(19) United States
(12) Patent Application Publication
(10) Pub. No.: US 2022/0415212 A1
(43) Pub. Date: Dec. 29, 2022

(54) SAFETY LABEL AND BARRIER

(71) Applicant: Jeff Mellott, Lone Butte (CA)

(72) Inventor: Jeff Mellott, Lone Butte (CA)

(21) Appl. No.: 17/304,867

(22) Filed: Jun. 28, 2021

(51) Int. Cl. G09F 3/02

(52) U.S. Cl. CPC G09F 3/02; G09F 2003/0208; G09F 2003/0276

(57) ABSTRACT

A safety label and barrier that is configured to provide a first notification and a second notification about an area to which the safety label and barrier is proximate. The present invention includes a body wherein the body is provided as a rolled material. The body includes a first notification area wherein the first notification area has a first notification thereon. The first notification area is in a first color. Adjacent to the first notification area is a second notification area. The second notification area is a different color than the first notification area. The second notification area has a second notification thereon. The second notification area is in between each first notification area along the entire length of the body. The second notification area includes portions that are completed by a user of the safety label and barrier.

### FIELD OF THE INVENTION

The present invention relates generally to construction site safety, more specifically but not by way of limitation, a safety label and barrier wherein the present invention employs a combined technique that provides a first notification and a second notification using the same structure to provide both notifications.

### BACKGROUND

As is known in the art, construction sites, industrial sites and similar environments have many hazards. All of the aforementioned have regulations that are specific to each so as to facilitate a safe environment for those individuals who are within these areas. One of the many safety elements deployed in areas is the conventional safety barricade tape. This tape is typically a high visibility in color and uses labeling indicia such as but not limited to caution or danger. The standard barricade tape is typically hung either around a dangerous area or can be used proximate an entry to an area that contains a hazard. For some industrial sites there is a further requirement to not only utilize the safety tape but to further make visible a tag. The tag is supposed to be secured to the safety tape in many locations along the safety tape and is operable to provide detailed information about the hazard that includes details such as but not limited to specifications on the hazard.

One problem with the existing method is that many times tags are not hung or they will fall off and are not replaced. The tags must be supplied separately which results in a higher expense. Additionally, the workers must spend time retrieving the tags, completing the information on the tags and then suspending the tags on the safety tape in the required locations. All of the aforementioned leads to tags either not being utilized properly or not replaced once they have fallen from the safety tape. This creates more risk around the hazard as individuals no longer have readily available the specific information about the hazard. Providing a more efficient technique for safety labeling would save organizations thousands of dollars.

Accordingly, there is a need for a safety label that includes a body wherein the body is configured to be dispensed around or proximate to a hazardous area wherein the body includes a first indicia area and a second indicia area operable to provide both a first notification and a second notification.

### SUMMARY OF THE INVENTION

It is the object of the present invention to provide a safety label and barrier that is configured to be placed proximate a hazardous area wherein the present invention includes a body that is elongated and planar in manner.

Another object of the present invention is to provide a safety label configured to provide a first notification and a second notification wherein the body of the present invention includes a plurality of first notification areas.

A further object of the present invention is to provide a safety label and barrier that is configured to be placed proximate a hazardous area wherein the body includes a plurality of second notification areas.

Still another object of the present invention is to provide a safety label configured to provide a first notification and a second notification wherein the first notification areas and second notification areas are adjacent.

An additional object of the present invention is to provide a safety label and barrier that is configured to be placed proximate a hazardous area wherein the body is provided in a roll of material such as but not limited to plastic.

Yet a further object of the present invention is to provide a safety label configured to provide a first notification and a second notification wherein the second notification area provides specification details on the hazard proximate to the suspended safety label.

Another object of the present invention is to provide a safety label and barrier that is configured to be placed proximate a hazardous area wherein the first notification area is provided in a first color.

Still an additional object of the present invention is to provide a safety label configured to provide a first notification and a second notification wherein the second notification area is provided in a second color.

Still a further object of the present invention is to provide a safety label and barrier that is configured to be placed proximate a hazardous area wherein the second notification area is provided in a second color.

Yet an additional object of the present invention is to provide a safety label configured to provide a first notification and a second notification wherein the second notification area is approximately eight inches in length and present every ten feet on the body of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the present invention; and

FIG. 2 is a front view of an alternate embodiment of the present invention.

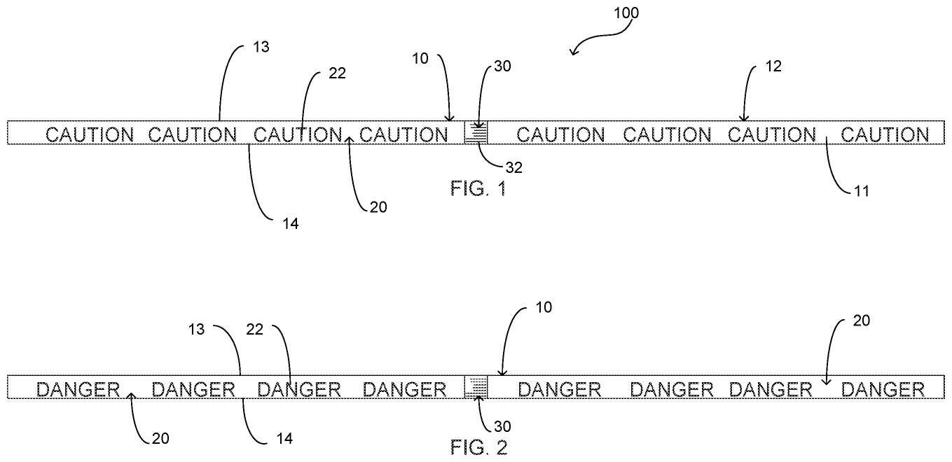

### DETAILED DESCRIPTION

Referring now to the drawings submitted herewith, wherein various elements depicted therein are not necessarily drawn to scale and wherein through the views and figures like elements are referenced with identical reference numerals, there is illustrated a safety label and barrier 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the safety label and barrier 100 includes a body 10. The body 10 is manufactured from a lightweight durable material such as but not limited to plastic. The body 10 is provided in an elongated shape and is planar in manner having a first side 11 and a second side 12. The body 10 is provided in a rolled format and a portion thereof is dispensed from the roll and placed in a desired area. While no specific length of the body 10 is required, it is contemplated within the scope of the present invention that the body 10 is provided in at least one hundred foot rolls. Additionally, while no particular width of the body 10 is required, it is desired within the scope of the present invention that the body 10 has a width of three inches from the upper perimeter edge 13 to the lower perimeter edge 14.

The body 10 has thereon a first notification area 20. The first notification area 20 includes a first notification 22. The first notification 22 is indicia wherein the indicia is directed towards a general warning such as caution or danger. The first notification area 20 is intermediate the upper perimeter edge 13 and the lower perimeter edge 14. The first notification area 20 is provided in a first color. It should be understood within the scope of the present invention that the first notification area 20 could be provided in various alternate high visibility colors. Additionally, it should be understood within the scope of the present invention that the first notification 22 is provided in a large font that extends substantially in between the upper perimeter edge 13 and lower perimeter edge 14.

Adjacent to the first notification area 20 is the second notification area 30. The second notification area 30 is configured to provide additional information regarding the hazardous area to which the safety label and barrier 100 has been placed proximate. The second notification area 30 includes a second notification 32 that provides information such as but not limited to name of installer of the safety label and barrier 100, hazard specifications, company name and contact information. The second notification area 30 is adjacent to the first notification area 20 and is present along the entire body 10 of the safety label and barrier 100. The second notification area 30 in a desired embodiment of the present invention is placed every ten feet on the body 10. Furthermore, it is desired within the scope of the present invention that the second notification area 30 is at least eight inches in length so as to allow for sufficient space to display the aforementioned information.

The second notification area 30 is provided in a second color. The second color of the second notification area 30 is a high visibility color. The second color of the second notification area 30 is different than that of the first color of the first notification area 20. It should be understood within the scope of the present invention that the first color and second color could be many different colors but that the first color and second color must always be different.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A safety label and barrier that is configured to be placed proximate a hazardous area wherein the safety label and barrier comprises:
a body, said body being elongated in manner, said body having a first side and a second side, said body being planar, said body having an upper perimeter edge and a lower perimeter edge;
a plurality of first notification areas, said plurality of first notification areas having a first notification thereon;
a plurality of second notification areas, said plurality of first notification areas being placed in between each of the plurality of first notification areas such that the plurality of first notification areas and the plurality of second notification areas alternate along the body; and
wherein the plurality of second notification areas include a second notification having different information that the first notification.

2. The safety label and barrier configured to be placed proximate a hazardous area as recited in claim 1, wherein the first notification area is provided in a first color.

3. The safety label and barrier configured to be placed proximate a hazardous area as recited in claim 2, wherein the second notification area is provided in a second color.

4. The safety label and barrier configured to be placed proximate a hazardous area as recited in claim 3, wherein the first color and second color are different.

5. The safety label and barrier configured to be placed proximate a hazardous area as recited in claim 4, wherein the second notification provided specifications on a hazard to which the safety label and barrier is proximate.

6. The safety label and barrier configured to be placed proximate a hazardous area as recited in claim 5, wherein the first notification extends substantially intermediate the upper perimeter edge and lower perimeter edge of the body.

7. The safety label and barrier configured to be placed proximate a hazardous area as recited in claim 6, wherein the second notification area is approximately eight inches in length.

8. The safety label and barrier configured to be placed proximate a hazardous area as recited in claim 7, wherein the second notification area is placed approximately every ten feet along the body.
